(19) United States
(12) Patent Application Publication
(10) Pub. No.: US 2013/0050248 A1
(43) Pub. Date: Feb. 28, 2013

(54) COLOR DISPLAY METHOD AND COLOR DISPLAY APPARATUS

(71) Applicant: Masaki NOSE, Ebina (JP)

(72) Inventor: Masaki NOSE, Ebina (JP)

(73) Assignee: FUJITSU LIMITED, Kawasaki-shi (JP)

(21) Appl. No.: 13/535,769

(22) Filed: Jun. 28, 2012

(30) Foreign Application Priority Data
Aug. 25, 2011 (JP) 2011-183584

(51) Int. Cl. G09G 5/02

(52) U.S. Cl. 345/596; 345/589

(57) ABSTRACT

A color display method in which display is realized by controlling, on the basis of image data having three primary colors, a reflective color display element in which three display panels are stacked, the color display method includes: converting the image data having the three primary colors into color space image data; classifying an image into one of a plurality of categories on the basis of criteria relating to brightness, hues, and chroma of the image; correcting the brightness of the color space image data in accordance with correction characteristics of the corresponding category; correcting the chroma of the color space image data whose brightness has been corrected; and converting the color space image data whose chroma has been corrected into image data having the three primary colors.

### CROSS-REFERENCE TO RELATED APPLICATION(S)

This application is based upon and claims the benefit of priority of the prior Japanese Patent Application No. 2011-183584, filed on Aug. 25, 2011, the entire contents of which are incorporated herein by reference.

### FIELD

The embodiments discussed herein are related to a color display method and a color display apparatus.

### BACKGROUND

Currently, corporations and universities are enthusiastically developing electronic paper. Electronic paper is expected to be applied to electronic books, as well as to sub-displays of mobile terminals, display units of integrated circuit (IC) cards, and various other devices.

One of dominant types of electronic paper is a liquid crystal display panel including a cholesteric liquid crystal. The liquid crystal display panel including a cholesteric liquid crystal has excellent characteristics such as semi-permanent display retention property (memorability), vivid color display, high contrast, and high resolution.

In particular, a reflective color display apparatus in which three liquid crystal display panels including a cholesteric liquid crystal are stacked has characteristics that display is bright and the color reproduction range is large compared to electronic paper of another type such as an electrophoretic type. However, even such a reflective color display apparatus does not have sufficient color reproducibility compared to a backlight liquid crystal display (LCD) or the like.

In current LCDs, efforts are made to improve the quality of images to be displayed by correcting image data to be supplied. In the reflective color display apparatus in which the three display panels are stacked, it is important to improve the quality of images to be displayed by correcting image data. However, a general method for correcting image data suitable for the reflective color display apparatus in which the three display panels are stacked has not been known. In addition, sufficient correction effects are not obtained just by applying a general method for correcting image data to the reflective color display apparatus in which the three display panels are stacked because display characteristics are different, and therefore the quality of images to be displayed is difficult to improve.

[Patent Document] Japanese Laid-open Patent Publication No. 2003-339057

[Patent Document] Japanese Laid-open Patent Publication No. 2006-30998

[Patent Document] International Publication Pamphlet No. WO 2007/004280

### SUMMARY

According to an aspect of the embodiments, a color display method in which display is realized by controlling, on the basis of image data having three primary colors, a reflective color display element in which three display panels are stacked, the color display method includes: converting the image data having the three primary colors into color space image data; classifying an image into one of a plurality of categories on the basis of criteria relating to brightness, hues, and chroma of the image; correcting the brightness of the color space image data in accordance with correction characteristics of the corresponding category; correcting the chroma of the color space image data whose brightness has been corrected; and converting the color space image data whose chroma has been corrected into image data having the three primary colors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating states of a cholesteric liquid crystal;

FIGS. 2A to 2F are diagrams illustrating examples of voltage response characteristics against pulses having various periods when the initial state of a cholesteric liquid crystal display element is a planar state;

FIG. 3 is a cross-sectional view of a reflective color display element having a three-layer structure;

FIG. 4 is a diagram illustrating the reflection spectrum of each layer of the reflective color display element in the planar state;

FIG. 5 is a diagram illustrating the color reproduction range of color electronic paper adopting the cholesteric liquid crystal;

FIG. 6 is a diagram illustrating an example of the color reproduction range of the cholesteric liquid crystal in the CIELAB color space;

FIG. 7 is a block diagram illustrating the schematic configuration of a reflective color display apparatus according to a first embodiment adopting a simple matrix type reflective color display element in which three display panels including the cholesteric liquid crystal are stacked;

FIG. 8 is a diagram illustrating the basic configuration of a simple matrix type panel according to the first embodiment adopting the cholesteric liquid crystal;

FIG. 9 is a diagram illustrating function blocks realized in a drive control circuit by a digital signal processor (DSP) (or a processor);

FIGS. 10A and 10B are diagrams illustrating the Munsell color system, FIG. 10A illustrating a color solid and FIG. 10B illustrating coordinate axes of the Munsell color system;

FIG. 11 is a diagram illustrating the operation flow of a process for correcting colors executed by the drive control circuit of the reflective color display apparatus according to the first embodiment;

FIGS. 12A to 12C are diagrams illustrating the distribution of brightness of pixels in an image of a first category (TYPE-1) and a process for correcting brightness;

FIGS. 13A to 13C are diagrams illustrating the distribution of brightness of pixels in an image of a second category (TYPE-2) and a process for correcting brightness;

FIGS. 14A to 14C are diagrams illustrating the distribution of brightness of pixels in an image of a third category (TYPE-3) and a process for correcting brightness;

FIGS. 15A to 15C are diagrams illustrating the distribution of brightness of pixels in an image of a fourth category (TYPE-4) and a process for correcting brightness;

FIG. 16 is a diagram illustrating an example of a conversion curve in chroma correction performed in the same way regardless of the categories and an example of the conversion curve (tone curve) for chroma enhancement;

FIGS. 17A and 17B are diagrams illustrating examples of a conversion curve (tone curve) in a process for correcting chroma in which the colors of plants and blue sky become vivid;

FIG. 18 is a diagram illustrating the distribution of colors in a plane defined by orthogonal axes Cr and Cb and directions in which the colors of blue sky and plants are corrected in the chroma enhancement;

FIG. 19 is a diagram illustrating the operation flow of a process for correcting colors executed by a drive control circuit of a reflective color display apparatus according to a second embodiment; and

FIGS. 20A and 20B are diagrams illustrating conversion characteristics for correcting differences in changes in brightness and response characteristics between R, G, and B layers when the widths of write pulses have been changed by conventional driving in a reflective color display apparatus in which liquid crystal panels including a cholesteric liquid crystal are stacked.

### DESCRIPTION OF EMBODIMENTS

Before describing embodiments, the operation principle of a display element adopting a cholesteric liquid crystal will be described.

A cholesteric liquid crystal is also referred to as a chiral nematic liquid crystal and is a liquid crystal in which the molecules of a nematic liquid crystal form a helical cholesteric phase when a relatively large amount (tens of percent) of a chiral additive (also referred to as a chiral material) has been added to the nematic liquid crystal. A display element adopting a cholesteric liquid crystal controls display using the orientation state of liquid crystal molecules therein.

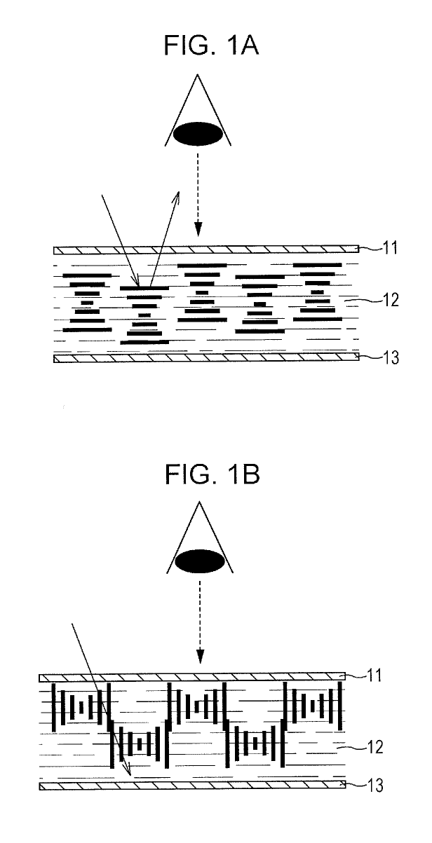

FIGS. 1A and 1B are diagrams illustrating states of a cholesteric liquid crystal. As illustrated in FIGS. 1A and 1B, a display element 10 adopting a cholesteric liquid crystal has an upper substrate 11, a cholesteric liquid crystal layer 12, and a lower substrate 13. A cholesteric liquid crystal may be in a planar state, in which, as illustrated in FIG. 1A, incident light is reflected thereby, or in a focal conic state, in which, as illustrated in FIG. 1B, incident light passes therethrough. These states are stably maintained even when no electric field is present.

In the planar state, the cholesteric liquid crystal reflects light having a wavelength corresponding to the helical pitch of liquid crystal molecules thereof. A wavelength λ at which the degree of reflection is largest is represented by the following expression using the average index of refraction n and the helical pitch p: λ=n·p

On the other hand, a reflection bandwidth Δλ becomes larger as the anisotropy Δn in the index of refraction of the liquid crystal becomes larger.

In the planar state, since incident light is reflected, the display element 10 may display a particular color. On the other hand, in the focal conic state, by providing a light absorption layer under the lower substrate 13, light that has passed through the cholesteric liquid crystal layer 12 is absorbed, and therefore the display element 10 may display black.

Next, the driving principle of the display element adopting a cholesteric crystal will be described.

When a strong electric field is applied to a liquid crystal, the helical structure of liquid crystal molecules is completely broken and the homeotropic state is established, in which all the molecules follow the direction of the electric field. Next, when the strength of the electric field is suddenly reduced to zero in the homeotropic state, the helical axis of the liquid crystal is oriented perpendicular to electrodes and the planar state is established, in which light corresponding to the helical pitch is selectively reflected. On the other hand, when an electric field that is weak enough to maintain the helical structure of the liquid crystal molecules has been removed after the electric field is generated, or when a strong electric field has been applied and then gradually removed, the helical axis of the liquid crystal becomes parallel to the electrodes and the focal conic state is established, in which incident light passes through the liquid crystal. In addition, when an electric field having a moderate strength has been applied and then suddenly removed, the planar state and the focal conic state coexist, thereby enabling display of middle tones. Information is displayed by utilizing these phenomena.

A lot of methods have been disclosed as driving methods to be used to display an image on the display element adopting a cholesteric liquid crystal, and these methods may be roughly divided into “conventional driving methods” and “dynamic driving methods”. In a dynamic driving method, a transient planar state is used in addition to the homeotropic state, the planar state, and the focal conic state, which have been described above. In a dynamic driving method, the content of display may be updated at relatively high speed, but there has been a problem in that precise tone control is difficult. In contrast, in a conventional driving method, it is possible to realize high-definition display by performing precise tone control, but there has been a problem in that it takes an extended period of time to update the content of display. Here, a case in which the display element adopting a cholesteric liquid crystal is driven by a conventional driving method will be described as an example.

In a conventional driving method, a reset operation is performed in which high voltage is applied to all pixels to establish the homeotropic state and then an electric field is removed and all the pixels enter the planar state or the focal conic state. Thereafter, using a simple matrix driving method, a write operation is performed in which write pulses having relatively low voltages and small pulse widths are applied in order to change the states of the individual pixels from the planar state or the focal conic state. Here, a case will be described as an example in which all the pixels enter the planar state through the reset operation and then, by the write operation, the planar state is maintained or changed to the focal conic state or a state in which the planar state and the focal conic state coexist is established.

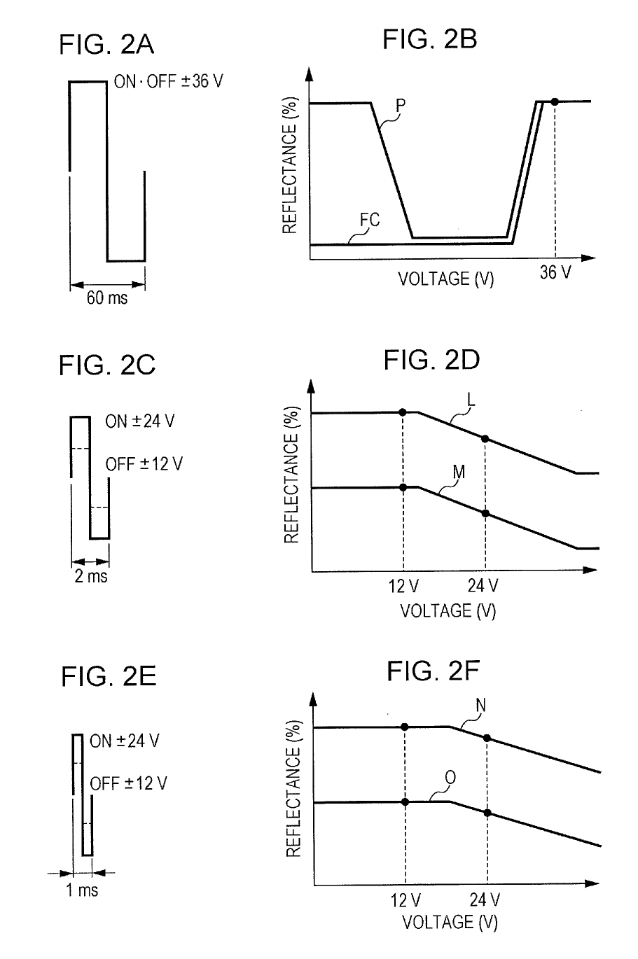

FIGS. 2A to 2F are diagrams illustrating examples of a voltage waveform applied to a liquid crystal cell (pixel) in a conventional driving method and examples of the response characteristics of the reflectance when the illustrated corresponding voltage waveform is applied in the conventional driving method. FIG. 2A illustrates a reset voltage waveform (pulses) to be applied in the reset operation. FIG. 2B illustrates a response to the application of the reset pulses. FIG. 2C illustrates an example of a write voltage waveform (pulses) to be applied in the write operation. FIG. 2D illustrates a response to the application of the write pulses illustrated in FIG. 2C when the initial state is the planar state. FIG. 2E illustrates write pulses having widths smaller than those of the write pulses illustrated in FIG. 2C. FIG. 2F illustrates a response to the application of the write pulses illustrated in FIG. 2E when the initial state is the planar state. In other words, FIGS. 2D and 2F illustrate changes in an inclination in the left part of a line P illustrated in FIG. 2B.

As in the case of a general liquid crystal, the driving waveform of a cholesteric liquid crystal is set as an alternating current waveform when deterioration (polarization) of a liquid crystal material is to be suppressed. Therefore, a liquid crystal driver IC (a cholesteric liquid crystal IC or a super-twisted nematic (STN) liquid crystal IC is generally used) has a function of reversing the polarity of an electric field applied to a liquid crystal cell. As a high-voltage power supply for driving the liquid crystal, a single power supply having tens of volts positive may be used.

First, changes in the state that are caused when pulse voltage is gradually increased from 0 V in a case in which the pulse illustrated in FIG. 2A having a wide pulse width, namely 60 ms, which is the sum of the pulse widths of positive and negative pulses, is applied will be described. When the initial state is the planar state, the state changes along the line P illustrated in FIG. 2B. When the pulse voltage has exceeded a certain voltage, the focal conic state is gradually established and the reflectance sharply drops. After reaching the minimum value, the reflectance hardly changes unless the pulse voltage exceeds a certain voltage. When the pulse voltage has exceeded the certain voltage, the planar state is gradually established and the reflectance sharply rises. After reaching the maximum value, the reflectance does not change even if the pulse voltage is increased. Such voltage-reflectance characteristics are generally called “VR characteristics”. When the initial state is the focal conic state, the state changes along a line FC illustrated in FIG. 2B. The reflectance does not change unless the pulse voltage exceeds a certain voltage. When the pulse voltage has exceeded the certain voltage, the planar state is gradually established and the reflectance sharply rises. After reaching the maximum value, the reflectance does not change even if the pulse voltage is increased. Regardless of the initial state being the planar state or the focal conic state, a planar state in which the reflectance has the maximum value is invariably established when a voltage equal to or higher than a certain value is applied. In FIG. 2B, when a pulse having a pulse width of 60 ms and a voltage of ±36 V is applied, the planar state is invariably established. Therefore, this pulse may be used as a reset pulse.

If a pulse having a pulse width smaller than that described above is applied, the responsibility changes. For example, when a pulse having a pulse width of 2 ms and a pulse voltage of ±24 V or ±12 V illustrated in FIG. 2C has been applied, the state changes along a line L illustrated in FIG. 2D if the initial state is the planar state. In FIG. 2D, the reflectance does not change in the case of the pulse having a pulse voltage of ±12 V, and the planar state is maintained. In the case of the pulse having a pulse voltage of ±24 V, the reflectance slightly decreases, thereby obtaining a middle tone. In addition, when the initial state is a state in which the planar state and the focal conic state coexist and the reflectance has a moderate value, the state changes along a line M illustrated in FIG. 2D. In this case, too, the reflectance does not change in the case of the pulse having a pulse voltage of ±12 V. In the case of the pulse having a pulse voltage of ±24 V, the reflectance slightly decreases.

Furthermore, when a pulse having a pulse width of 1 ms and a pulse voltage of ±24 V or ±12 V illustrated in FIG. 2E has been applied, the state changes along a line N illustrated in FIG. 2F if the initial state is the planar state. In FIG. 2F, the reflectance does not change in the case of the pulse having a pulse voltage of ±12 V, and the planar state is maintained. In the case of the pulse having a pulse voltage of ±24 V, the reflectance slightly decreases and a middle tone is obtained; however, the amount of decrease in reflectance is smaller than in the case of the pulse having a pulse width of 2 ms. That is, the tone is darker in the case of the pulse having a pulse width of 2 ms than in the case of the pulse having a pulse width of 1 ms. When the initial state is a state in which the planar state and the focal conic state coexist and the reflectance has a moderate value, the state changes along a line O illustrated in FIG. 2F. In this case, too, the reflectance does not change in the case of the pulse having a pulse voltage of ±12 V. In the case of the pulse having a pulse voltage of ±24 V, the reflectance slightly decreases.

It may be seen from the above description that if the initial state is the planar state, the reflectance decreases when a pulse having a relatively small voltage has been applied, and the amount of decrease in reflectance varies depending on the pulse voltage and the pulse width. More specifically, the higher the pulse voltage, and the larger the pulse width, the larger the amount of decrease in reflectance. In addition, as may be seen from changes represented by the lines M and O in FIGS. 2D and 2F, respectively, the same changes are caused even when pulses have been applied separately, and the amount of decrease in reflectance depends on the sum of the pulse widths, that is, the cumulative time of application of the pulses.

An example has been described in which the initial state is the planar state and the inclination in the left part of the line P illustrated in FIG. 2B is utilized. However, the same holds true for a case in which the initial state is the focal conic state and an inclination in the right part of the line FC illustrated in FIG. 2B is utilized.

Furthermore, various driving methods have been proposed as the conventional driving methods; however, detailed description thereof is omitted herein.

As described above, there are various driving method having respective advantages and disadvantages. Therefore, an appropriate driving method is selected in accordance with the usage. A display element adopting a cholesteric liquid crystal according to an embodiment, which will be described hereinafter, may use any of the above-described driving methods.

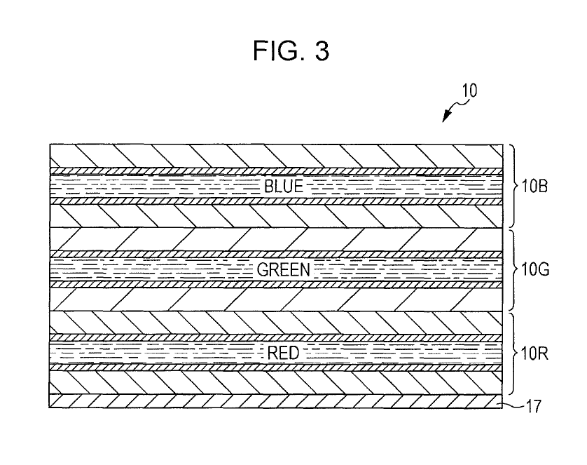

FIG. 3 is a schematic cross-sectional view of a reflective color display element in which three cholesteric liquid crystal layers are stacked.

As illustrated in FIG. 3, in a display element 10, a blue panel 10B, a green panel 10G, and a red panel 10R are stacked in this order from a surface to be seen. A light absorption layer 17 is provided under the red panel 10R. The blue panel 10B, the green panel 10G, and the red panel 10R have the same configuration, but the liquid crystal materials and the chiral materials thereof are selected and the percentages of the chiral materials are determined such that the center wavelength of reflection of the blue panel 10B becomes a wavelength of blue, that of the green panel 10G becomes a wavelength of green, and that of the red panel 10R becomes a wavelength of red. The stacked three panels each include pixels formed therein, and pixels of the reflective color display element include the pixels of the stacked three panels. The pixels of each panel exhibit a certain reflected color. In a multilayer method, the area ratio of each pixel of R, G, or B in a pixel is 100%. On the other hand, in the case of electronic paper adopting another method, the area ratio of each pixel of R, G, or B in a pixel is 33% at maximum. Therefore, the color display of the cholesteric liquid crystal has an advantage over other methods in the quality of images such as brightness and vividness.

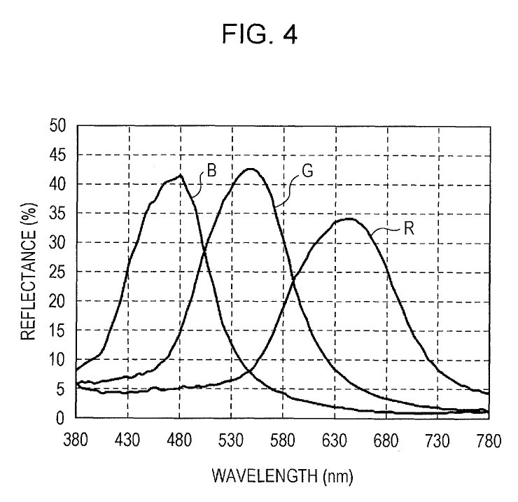

FIG. 4 is a diagram illustrating a representative example of the spectral reflection characteristic of each layer used in the reflective color display element illustrated in FIG. 3 in the planar state. In FIG. 4, reflection spectra B, G, and R are obtained from the blue layer 10B, the green layer 10G, and the red layer 10R, respectively. In FIG. 4, the spectral reflection characteristic of each layer approximately has the normal distribution. The center wavelength of reflection of the blue layer 10B is about 480 nm, that of the green layer 10G is about 550 nm, and that of the red layer 10R is about 630 nm. In a reflective color display element, the spectral reflection characteristic of each layer is ideally rectangular. Although the spectral reflection characteristics illustrated in FIG. 4 are not rectangular, each layer still has a good characteristic in realizing color display. In the planar state, a cholesteric liquid crystal reflects circularly polarized light incident thereon from one side and lets circularly polarized light incident thereon from another side pass therethrough, and therefore the maximum theoretical reflectance is 50%.

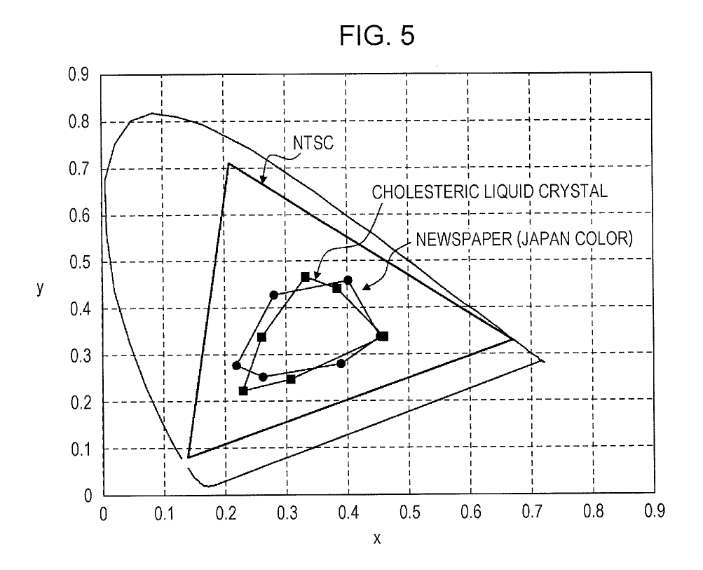

FIG. 5 is a diagram illustrating the color reproduction range of color electronic paper adopting a cholesteric liquid crystal. In FIG. 5, “NTSC” represents a color reproduction range according to a National Television System Committee (NTSC) standard, which is generally used as an index of the color reproduction range of a display. “Cholesteric liquid crystal” represents the color reproduction range of the color electronic paper adopting a cholesteric liquid crystal. “Newspaper (Japan color)” represents the color reproduction range of color printing on a piece of newspaper. The area of a color reproduction range is expressed as a ratio to the NTSC color reproduction range. The larger the NTSC ratio, the brighter the displayed colors. Currently, the NTSC ratio may exceed 100% in luminescent displays such as a backlight liquid crystal display (LCD), a plasma display panel (PDP), and an organic electroluminescent (EL) display. Some inkjet printers also have an NTSC ratio close to 100%.

In comparison with these displays, the NTSC ratio of a reflective display such as electronic paper is significantly low. In the case of the above-described configuration, in which sub-pixels R, G, and B, each of which has one-third of the area of a pixel, are provided in the pixel, the NTSC ratio is about 10% at maximum. On the other hand, in the case of a reflective color display apparatus adopting a cholesteric liquid crystal (hereinafter also referred to simply as the “cholesteric liquid crystal”), the NTSC ratio may exceed 20%. Since the NTSC ratio of a piece of newspaper is about 20%, the NTSC ratio of the cholesteric liquid crystal is substantially the same as that of a piece of newspaper.

Next, a case will be described in which a color reproduction range is evaluated using the CIELAB color space, which is a three-dimensional uniform color space, as a method for identifying the color reproduction range in a more accurate manner.

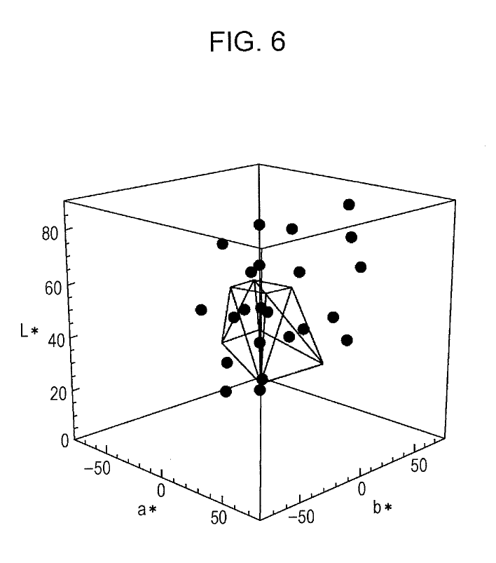

FIG. 6 is a diagram illustrating an example of the color reproduction range of a cholesteric liquid crystal in the CIELAB color space. In FIG. 6, the Macbeth color chart, which includes standard colors, is plotted in addition to the color solid of the cholesteric liquid crystal. In the case of the color solid of a self-luminous display, the range of the Macbeth color chart may be substantially covered (included), but the cholesteric liquid crystal does not have color reproducibility that may cover the Macbeth color chart, although a reflective display adopting the cholesteric liquid crystal has excellent color reproducibility compared to other reflective displays. Thus, since the color reproducibility of color electronic paper is still insufficient, colors are subdued and do not stand out when a photograph or an animation that may be displayed clearly by a luminescent display or a printer is displayed by the color electronic paper. Therefore, in the color electronic paper, correction of the quality of images to be displayed is significantly important.

In addition, unlike general displays, the color electronic paper mainly displays still images. In the case of displaying a moving image, a user does not recognize delay in the response to the correction of the quality of the image even if processing of the correction of the quality of the image takes some time, because the image is continuously played. On the other hand, since the color electronic paper is used by switching the display of still images using a button or the like, the user might undesirably recognize delay in the response to the switching of the display of the still images if it takes time to correct the quality of an image when the user has pressed the button to switch the display to a next image. Therefore, the correction of the quality of images is expected to be completed at high speed.

Various algorithms for correcting the quality of images have been proposed. However, there has been no method for correcting the quality of images on a reflective color display apparatus in which three display panels including a cholesteric liquid crystal are stacked. In addition, as described above, the color reproduction range of the reflective color display apparatus in which the three display panels are stacked is small compared to that of a self-luminous display, and therefore it is difficult to improve the quality of images using a general method for correcting image data.

Electronic paper of a reflective color display apparatus in which three display panels including a cholesteric liquid crystal are stacked according to the embodiment, which will be described hereinafter, executes correction of the quality of images that is suitable for the characteristics thereof, in order to improve the quality of display.

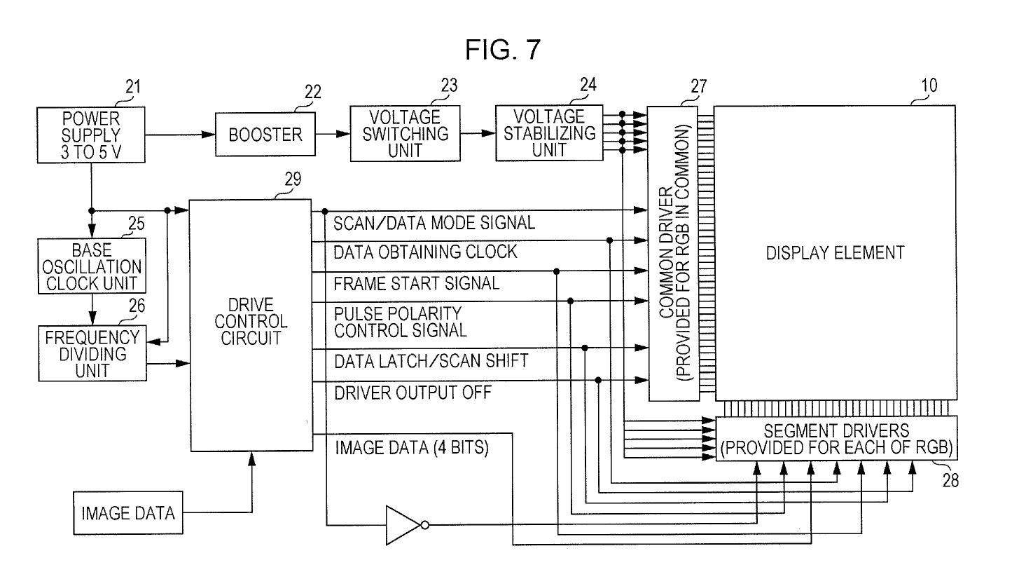

FIG. 7 is a block diagram illustrating the schematic configuration of a reflective color display apparatus according to a first embodiment adopting a simple matrix type reflective color display element in which three display panels including a cholesteric liquid crystal are stacked.

The display apparatus includes a display element 10, a power supply 21, a booster 22, a voltage switching unit 23, a voltage stabilizing unit 24, a base oscillation clock unit 25, a frequency dividing unit 26, a common driver 27, segment drivers 28, and a drive control circuit 29.

The display element 10 is the simple matrix type reflective color display element in which the three display panels including a cholesteric liquid crystal are stacked. The reflective color display element may be realized by a display material other than the cholesteric liquid crystal instead, so long as the reflective color display element has a multiplayer structure.

The number of pixels of the display element 10 is the Extended Graphics Array (XGA; 1,024 horizontal pixels and 768 vertical pixels). The method for driving the display element 10 is the above-described conventional driving method. However, a dynamic driving method may be used instead.

The power supply 21 is formed by a portion that receives power supplied from outside, a battery, or the like, and outputs a direct voltage of 3 to 5 V. The booster 22 has a DC/DC converter or the like and increases the direct voltage of 3 to 5 V to about 40 V, which is used as the driving voltage of the liquid crystal. This boost regulator preferably has high conversion efficiency relative to the load characteristics of the display element 10, that is, relative to the charge and discharge of a capacitor in a regular cycle.

The voltage switching unit 23 generates a voltage of 36 V from the increased voltage during the reset operation or an analog voltage (about 0, 10, 17, or 24 V) during the write operation, and outputs the voltage. A high-voltage analog switch is used for switching between the reset voltage and the tone writing voltage. A switching circuit including a simple transistor may be adopted instead.

The voltage stabilizing unit 24 has a voltage follower circuit of an operator amplifier and stabilizes the voltage during charge and discharge. The operator amplifier to be used is preferably one that is not easily affected by a capacitive load.

The base oscillation clock unit 25 generates base clock pulses that serve as the base of the operation. The frequency dividing unit 26 divides the base clock pulses in order to generate various clock pulses that are used for operations that will be described later.

An output terminal of the common driver 27 is connected to 768 common electrodes of the display element 10. Output terminals of the segment drivers 28 are connected to 1,024 segment electrodes of the display element 10. Since the common electrodes are selected by the three panels of R, G, and B in common, the common driver 27 is used by the three panels of R, G, and B in common. On the other hand, because image data applied to the segment electrodes of the three panels of R, G, and B is different between the three panels, the segment drivers 28 are separately provided for the three panels of R, G, and B, respectively. The common driver 27 and the segment drivers 28 may be realized by general-purpose binary-output STN drivers. A driver IC is expected to withstand a voltage of 40 V or more.

The drive control circuit 29 generates signals for controlling the components and supplies drive image data to the segment drivers 28, in order to update the display of the display element 10 on the basis of image data supplied from outside. The drive control circuit 29 converts a full-color original image (about 16,770,000 colors; 256 tones for each of R, G, and B) into an image having 4,096 colors (16 tones for each of R, G, and B) using a dither process such as error diffusion, in order to generate the drive image data to be output to the segment drivers 28. This conversion of tones may be performed using various methods in addition to the error diffusion, but a systematic dither method and a blue noise mask are preferable in terms of the quality of display. The drive control circuit 29 may be realized by a microcomputer, a field-programmable gate array (FPGA), or the like. In the first embodiment, a process for correcting colors is executed on image data regarding the full-color original image (about 16,770,000 colors; 256 tones for each of R, G, and B) before the dither process. This process will be described later.

When the display is to be updated, eight reset pulses having a voltage of ±36 V and pulse widths of 15 ms are applied to all the pixels, thereby executing the reset operation by which the planar state is established.

Next, the image data converted into 4,096 colors is input to the segment drivers 28 for R, G, and B. For example, in the case of the write operation utilizing accumulated responses, the image data regarding the 4,096 colors (16 tones for each of R, G, and B) is divided into pieces of binary image data (H1 to H7) corresponding to middle tones, and the write operation is executed seven times for the entirety of a screen. A voltage of ±24 V is applied to pixels whose tone levels are to be changed, and a voltage of ±10 V, to which the liquid crystal hardly responds, is applied to pixels whose tone levels are to be maintained. By enlarging this approach, display in 260,000 colors is possible.

The display element 10 is the simple matrix type reflective color display element illustrated in FIG. 3 in which the three display panels 10B, 10G, and 10R including a cholesteric liquid crystal are stacked.

The panels 10B, 10G, and 10R have the same configuration, except that the center wavelengths of reflection thereof are different. A representative example of the panels 10B, 10G, and 10R will be represented as a panel 10A, and the configuration of the panel 10A will be described.

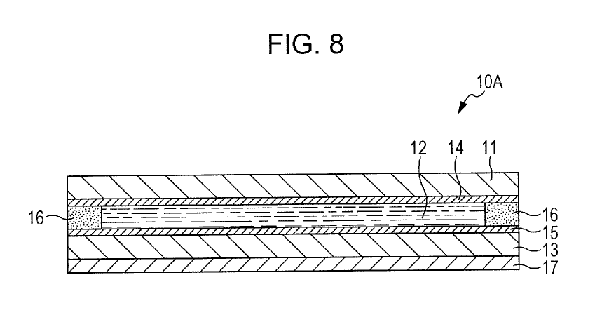

FIG. 8 is a diagram illustrating the basic configuration of the panel 10A.

As illustrated in FIG. 8, the display element 10A includes an upper substrate 11, an upper electrode layer 14 provided on a surface of the upper substrate 11, a lower electrode layer 15 provided on a surface of a lower substrate 13, and sealant 16. The upper substrate 11 and the lower substrate 13 are arranged such that electrodes thereof face each other. A cholesteric liquid crystal material is applied between the upper substrate 11 and the lower substrate 13 and then the sealant 16 is applied. Spacer is provided within a liquid crystal layer 12. A plurality of common electrodes are formed on either the upper electrode layer 14 or the lower electrode layer 15, and a plurality of segment electrodes are formed on the other, but these electrodes are not illustrated. The plurality of common electrodes and the plurality of segment electrodes are transparent strip electrodes that are arranged parallel to one another and disposed in such a way as to be perpendicular to each other when viewed from the surface to be observed. The common driver and the segment drivers apply voltage pulse signals to the plurality of common electrodes and the plurality of segment electrodes, thereby applying voltage to the liquid crystal layer 12. By applying the voltage to the liquid crystal layer 12, the planar state or the focal conic state is established in liquid crystal molecules in the liquid crystal layer 12 and display is realized.

The upper substrate 11 and the lower substrate 13 have transparency, but the lower substrate 13, which is the lowest panel in the multilayer structure, may be opaque. Substrates having transparency include a glass substrate, a polyethylene terephthalate (PET) film substrate, and a polycarbonate (PC) film substrate.

The upper electrode layer 14 and the lower electrode layer 15 are typically transparent conductive films composed of indium tin oxide (ITO). Alternatively, for example, transparent conductive films composed of indium zinc oxide (IZO) or the like may be used.

Insulating thin films are formed on the electrodes. If the insulating thin films are thick, the driving voltage increases and therefore it becomes difficult to use a general-purpose STN driver. On the other hand, if there are no insulating thin films, leakage current is undesirably generated and therefore the power consumption increases. The insulating thin films have a relative dielectric constant of about 5, which is much lower than that of a liquid crystal. Therefore, the thickness of the insulating thin films is preferably about 0.3 μm or less.

The spacer is inserted between the upper substrate 11 and the lower substrate 13 in order to maintain an even gap between the upper substrate 11 and the lower substrate 13. In general, spherical spacer composed of a resin or an inorganic oxide is evenly sprayed before the upper substrate 11 and the lower substrate 13 are attached to each other. Alternatively, fixing spacer coated with a thermoplastic resin may be provided. A cell gap formed by the spacer is preferably within the range from 3 to 6 μm. If the cell gap is smaller than this range, the reflectance decreases to cause the display to be dark, and high threshold steepness is not expected. On the other hand, if the cell gap is larger than the range, high threshold steepness may be maintained, but the driving voltage increases and accordingly driving using general-purpose components becomes difficult.

A liquid crystal composition to be applied to the liquid crystal layer 12 is a cholesteric liquid crystal obtained by adding a chiral material to a nematic liquid crystal mixture at a ratio of 10 to 40 wt %. Here, the amount of the chiral material to be added is a percentage when the total amount of the nematic liquid crystal component and the chiral material is assumed to be 100 wt %. As the nematic liquid crystal, various materials that are already known may be used, but the appropriate range of the dielectric anisotropy (As) is 15 to 25. If the dielectric anisotropy is 15 or less, the driving voltage becomes generally high and it is difficult to use a general-purpose component in a driving circuit. On the other hand, if the dielectric anisotropy is 25 or more, the range of applied voltage in which the planar state is changed to the focal conic state becomes small, and therefore the threshold steepness is considered to decrease. Furthermore, the reliability of the liquid crystal material itself becomes doubtful.

The anisotropy (Δn) in the index of refraction is preferably within the range from about 0.18 to 0.25. If the anisotropy in the index of refraction is smaller than this range, the reflectance in the planar state undesirably decreases. If the anisotropy in the index of refraction is larger than this range, the degree of scatter reflection in the focal conic state is undesirably large, viscosity is high, and response speed is low.

The configuration of a simple matrix type reflective color display element in which three display panels including a cholesteric liquid crystal are stacked and the configuration of a reflective color display apparatus adopting the simple matrix reflective color display element are widely known and known techniques may be used. Therefore, further detailed description of these configurations is omitted.

Next, correction of colors in image data for improving the quality of images executed by the drive control circuit 29 will be described.

The drive control circuit 29 includes a DSP, a memory, and the like, but a general-purpose processor may be used instead of the DSP. However, as described later, the DSP is preferable in terms of processing speed. The drive control circuit 29 corrects colors in such a way as to make maximum use of the limited color reproduction range of the simple matrix type reflective color display element in which the three display panels including a cholesteric liquid crystal are stacked. This process for correcting colors is a process that may be executed by the drive control circuit 29 at high speed.

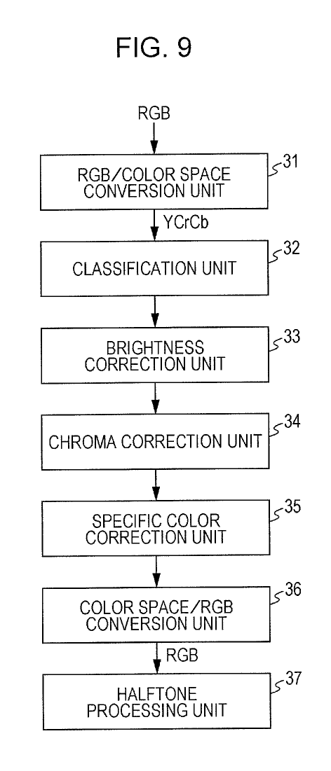

FIG. 9 is a diagram illustrating function blocks realized in the drive control circuit 29 by the DSP (or the processor).

The drive control circuit 29 includes an RGB/color space conversion unit 31, a classification unit 32, a brightness correction unit 33, a chroma correction unit 34, a specific color correction unit 35, a color space/RGB conversion unit 36, and a halftone processing unit 37.

The RGB/color space conversion unit 31 converts a full-color original image (about 16,770,000 colors; 256 tones for each of R, G, and B) into color space image data. The color space/RGB conversion unit 36 converts the color space image data that has been subjected the correction process into RGB image data.

The classification unit 32 classifies an image into one of a plurality of categories on the basis of evaluation criteria relating to the brightness, the hues and the chroma of the image in one screen. More specifically, the classification unit 32 calculates distribution information regarding brightness and the frequency of appearance of specific colors, and classifies an image into one of the plurality of the categories on the basis of the distribution information regarding brightness and the frequency of appearance of specific colors that have been obtained.

The brightness correction unit 33 corrects the brightness of the color space image data in accordance with correction characteristics of the corresponding category.

The chroma correction unit 34 corrects the chroma of the color space image data whose brightness has been corrected. The chroma correction may be different for each category or may be the same between the categories.

The specific color correction unit 35 judges whether or not the color space image data whose chroma has been corrected includes specific colors and, if any, corrects the hues or the chroma of the specific colors.

The halftone processing unit 37 executes, in accordance with the number of colors that may be displayed by the display element 10, halftone processing such as the above-described dither process on the RGB image data obtained as a result of the conversion executed by the color space/RGB conversion unit 36.

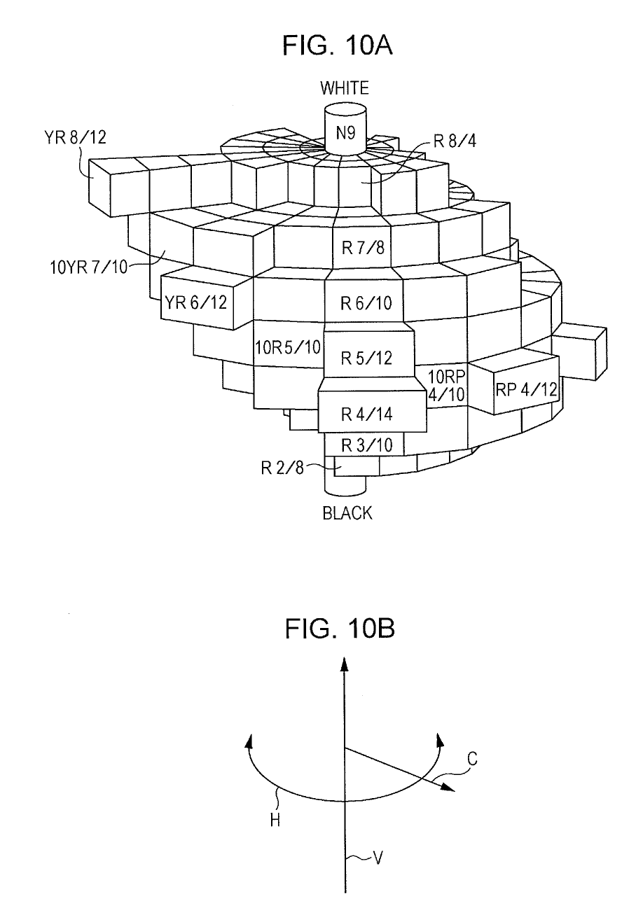

FIGS. 10A and 10B are diagrams illustrating the Munsell color system. FIG. 10A illustrates a color solid, and FIG. 10B illustrates coordinate axes of the Munsell color system. In the Munsell color system, colors have three attributes, namely hue (H), chroma (C), and brightness (V). It is to be noted for the following description that, as illustrated in FIG. 10A, yellow extends long along a chroma axis, which indicates the vividness of colors, in a high brightness region, and blue and red extend long along the chroma axis in a low brightness region.

The color space image data is, for example, YCbCr data. With respect to the color space, there are many types of color space that may define brightness and chroma, such as the well-known CIELAB color space and the HSV color space. In the first embodiment, the YCbCr color space, in which conversion using RGB values may be executed at high speed, is adopted.

When the image data is 8-bit data, the RGB data and the YCbCr color space data are converted using the following linear transformations. Conversion from RGB into YCbCr

Y=0.257R+0.504G+0.098B+16

Cb=−0.148R−0.291G+0.439B+128

Cr=0.439R−0.368G−0.071B+128

Conversion from YCbCr into RGB

R=1.164(Y−16)+1.596(Cr−128)

G=1.164(Y−16)−0.391(Cb−128)−0.813(Cr−128)

B=1.164(Y−16)+2.018(Cb−128)

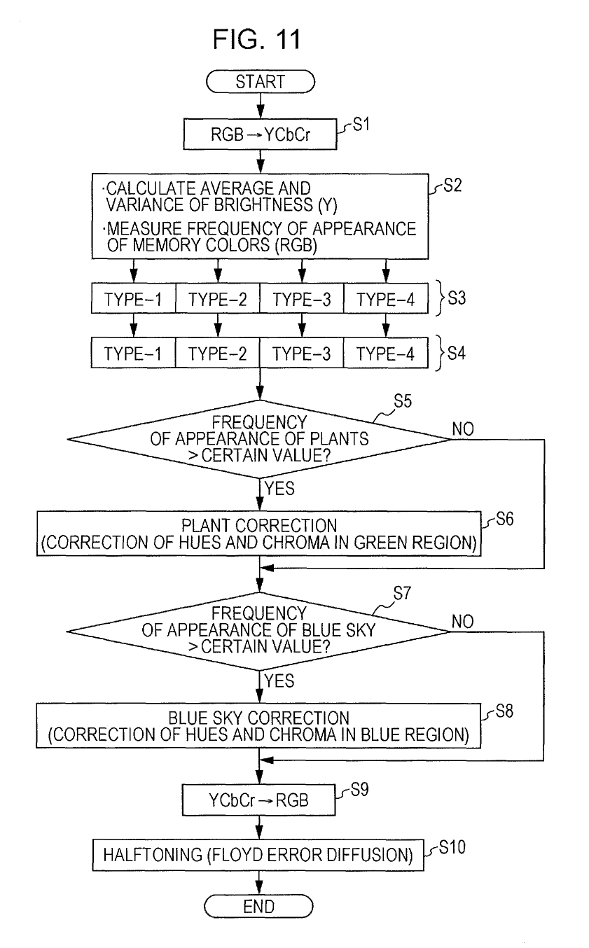

FIG. 11 is a diagram illustrating the operation flow of the process for correcting colors executed by the drive control circuit 29 in the reflective color display apparatus according to the first embodiment.

In step S1, the RGB/color space conversion unit 31 converts RGB image data regarding a full-color original image into color space image data YCbCr in accordance with the above expressions for converting RGB into YCbCr. A central processing unit (CPU) or the like realizes high-speed processing by executing these expressions only as integer arithmetic or shift operation.

In step S2, the classification unit 32 calculates the average and the variance of a Y value (brightness) of YCbCr and measures (calculates) the frequencies of appearance of memory colors. The memory colors are colors that tend to remain in the mind of a person, such as flesh colors and colors of blue sky and plants. The measurement of the frequencies of appearance of the memory colors may be easily performed by specifying the ranges of values of the memory colors in advance. Because the frequencies of appearance of the memory colors may be measured not only in YCbCr but also in RGB values, the measurement may be performed before step S1 when the RGB values are used.

In the first embodiment, for example, the ranges of values corresponding to slightly subdued flesh colors and colors of blue sky and plants are specified in advance, and the number of pixels corresponding to the ranges of values is measured. Because this measurement is performed for a classification process, the average and the variance of the Y value (brightness) and the ranges of values of the memory colors are specified in accordance with the categories that will be described later.

In step S3, the classification unit 32 classifies an image in one screen into, for example, one of four categories on the basis of the average and the variance of the brightness and the frequencies of appearance of the memory colors obtained in step S2. The brightness correction unit 33 corrects the brightness (the Y value) in accordance with the categories. Classification criteria of the categories and examples of the correction process will be described hereinafter.

FIGS. 12A to 12C are diagrams illustrating the distribution of the brightness of pixels in an image of a first category (TYPE-1) and a process for correcting the brightness.

As illustrated in FIG. 12A by a curve named “before correction”, the TYPE-1 image is a slightly dark image as a whole in which the values of brightness are small in many portions thereof. An image is regarded as dark when, for example, the average of brightness is 120 or less (the maximum value is 255 in the case of 8-bit data). In consideration of the brightness of the reflective color display element (color electronic paper) itself being not very high, this standard value of brightness may be set slightly higher instead. This is because it is desirable to judge that the image is “dark” even when the average value is moderate since the color electronic paper itself is not so bright, and, in addition, a dark image does not look good since the reflectance (brightness) and the black-white contrast of the color electronic paper are not very high.

In the correction process, brightness correction and contrast enhancement correction are performed. This holds true for the other categories (TYPEs). In the brightness correction, as illustrated in FIG. 12B, a conversion curve (tone curve) indicating conversion from input pixel values into output pixel values is located above a line having an inclination of 1, and the difference from the line is especially large at small input pixel values. In other words, the correction is generally performed in a brighter direction, and values of correction are especially large at small input pixel values. In FIG. 12B, the input pixel values are 8-bit L, and this holds true for FIG. 12C and FIGS. 13A to 15C.

In the contrast enhancement correction, as illustrated in FIG. 12C, correction is performed such that the tone curve has an S-shape, that is, so-called contrast enhancement, in which brighter pixels become brighter and darker pixels become darker, is performed. The sharpness of the image is effectively improved.

Although the brightness correction and the contrast enhancement correction have been separately described to clarify the description, a single operation of correction combining the brightness correction and the contrast enhancement correction is performed in practice. It is desirable to perform the correction using a lookup table (LUT) in terms of processing speed. This holds true for the processes that will be described later.

By the above-described correction, an image that has been slightly dark becomes brighter and the sharpness thereof is improved. In FIG. 12A, a curve named “after correction” indicates the distribution of brightness in the image after the above-described correction, which has had the distribution of brightness indicated by the curve named “before correction”.

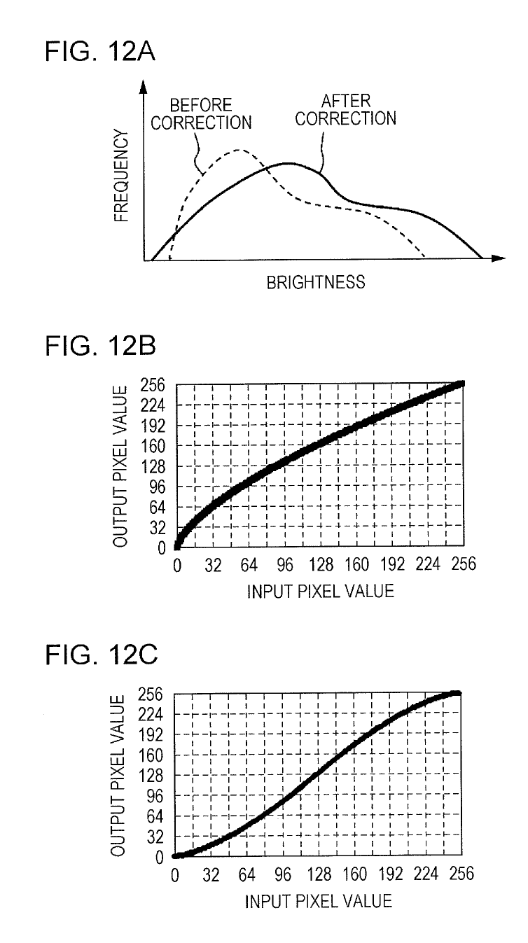

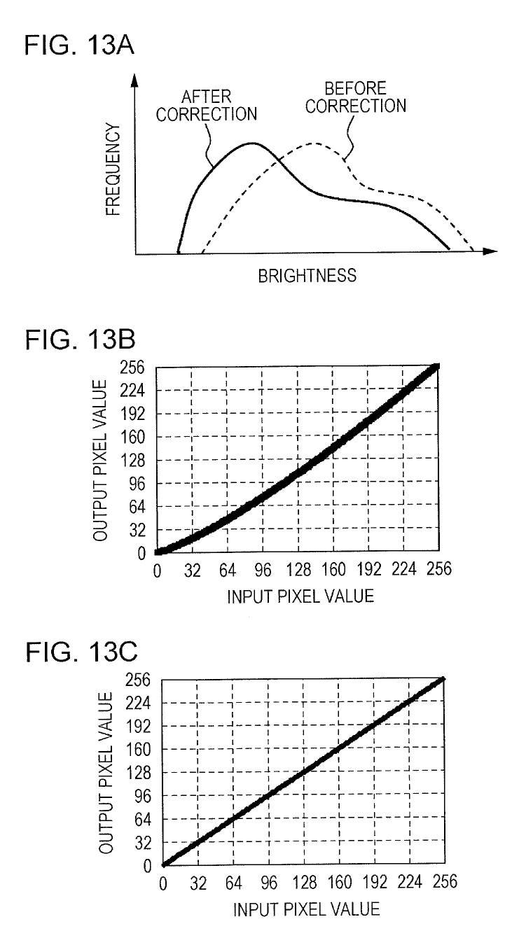

FIGS. 13A to 13C are diagrams illustrating the distribution of brightness of pixels in an image of a second category (TYPE-2) and a process for correcting the brightness.

As illustrated in FIG. 13A by a curve named “before correction”, the TYPE-2 image is a slightly bright image as a whole in which the values of brightness are large in many portions thereof. An image is regarded as bright when, for example, the average of brightness is 180 or more (the maximum value is 255 in the case of 8-bit data). In consideration of the brightness of the reflective color display element (color electronic paper) itself being not very high, this standard value of brightness may be set slightly higher instead. This means that the image may be regarded as “bright” only when the average value is very high.

The TYPE-2 image is typically an animation or an illustration. In the case of an animation or an illustration, the image looks better as the colors become more vivid.

In the brightness correction, as illustrated in FIG. 13B, a tone curve is located below a line having an inclination of 1, and the difference from the line is especially large at moderate input pixel values. In other words, the brightness is slightly decreased and the chroma is increased by tone curve correction. This is because, as illustrated in FIG. 10A, the chroma of noticeable colors such as blue and red may be easily increased when the brightness is relatively low.

With respect to the contrast enhancement correction, as illustrated in FIG. 13C, correction is performed such that the tone curve becomes substantially straight, that is, contrast enhancement is not particularly performed. This is because the contrast of an image such as an animation or an illustrated is already high before the correction, and therefore the contrast enhancement is unnecessary.

By the above-described correction, the colors of the image become more vivid and are not easily subdued even when the image is displayed on the color electronic paper. In FIG. 13A, a curve named “after correction” indicates the distribution of brightness in the image after the above-described correction, which has had the distribution of brightness indicated by the curve named “before correction”.

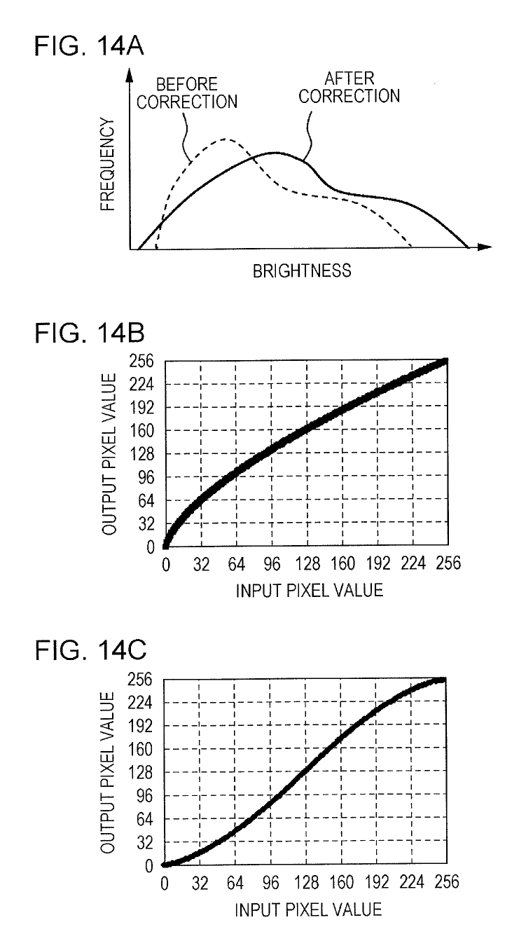

FIGS. 14A to 14C are diagrams illustrating the distribution of the brightness of pixels in an image of a third category (TYPE-3) and a process for correcting the brightness.

As illustrated in FIG. 14A by a curve named “before correction”, the TYPE-3 image is, as with the TYPE-1 image, a slightly dark image as a whole in which the values of brightness are small in many portions thereof, and subdued flesh colors are detected at a certain frequency. A criterion of the frequency of appearance of flesh colors is, for example, 3% or more of the entirety of the image. The ranges of RGB values that define flesh colors are, for example, R (red): 150 to 190, G (green): 100 to 140, and B (blue): 80 to 140. The ranges of YCbCr values corresponding to these ranges of RGB values are determined. These values are known information or based on experiments.

As illustrated in FIGS. 14B and 14C, the brightness correction and the contrast enhancement correction are the same as those for the TYPE-1 image. In the color electronic paper, flesh colors look dark and subdued when displayed as they are, and therefore the entirety of the image seems poor. For this reason, in images of this category (TYPE-3), flesh colors are treated as main colors, and the brightness is increased by the tone curve correction to remove shady portions. Thereafter, a certain degree of contrast enhancement is performed to improve the sharpness to some degree.

The flesh colors whose brightness have been corrected are then subjected to subsequent chroma correction in which the chroma thereof is increased, so that skins look healthy. Flesh colors are considered to seem pleasing when there is some redness therein. In doing so, the colors are not subdued even when the colors are displayed on the color electronic paper.

Images that do not fall into any of the above-described first category (TYPE-1) to third category (TYPE-3) are classified into a fourth category (TYPE-4).

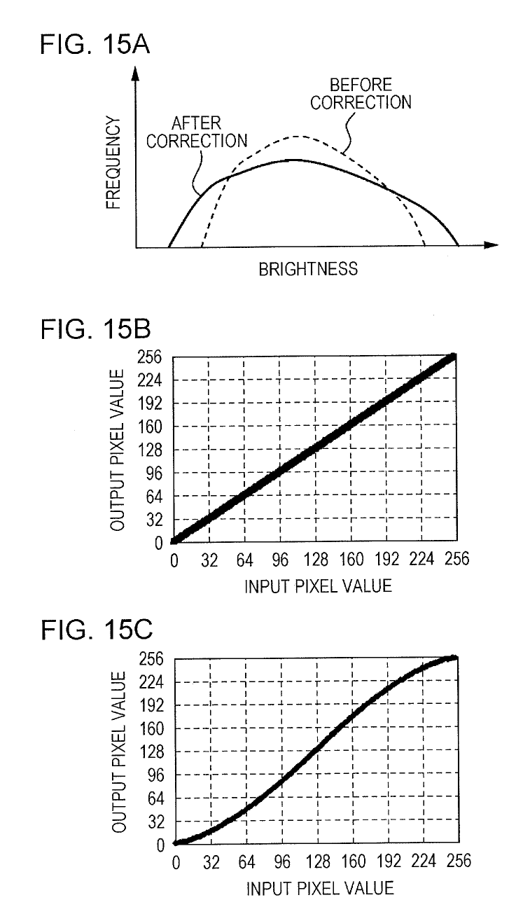

FIGS. 15A to 15C are diagrams illustrating an example of the distribution of the brightness of pixels in an image of the fourth category (TYPE-4) and a process for correcting the brightness.

With respect to the brightness correction, as illustrated in FIG. 15B, correction is performed such that the tone curve becomes substantially straight, that is, brightness correction is not particularly performed. With respect to the contrast enhancement correction, as illustrated in FIG. 15C, contrast enhancement is performed such that the tone curve has an S-shape, in order to improve the sharpness of the image.

Thus, since the TYPE-4 image is neither bright nor dark, the process for correcting brightness is not particularly performed and only contrast enhancement is performed. The sharpness is further improved by the contrast enhancement.

Color electronic paper that is currently used typically has a contrast of 10 or less, and therefore it is desirable to perform the contrast enhancement in most cases.

Furthermore, because the tone characteristics of color electronic paper largely depend on a liquid crystal material, the configuration of panels, and the driving method, optimum values are determined for the degree of the brightness correction and the degree (so-called “gamma”) of the contrast enhancement in accordance with the characteristics of a display apparatus. Gamma may typically be within a range of 0.5 to 2.0.

In step S4, the chroma correction unit 34 executes chroma correction on the color space image data YCbCr whose brightness has been corrected in accordance with the category (TYPE) thereof in step S3. The chroma correction may be performed regardless of the categories obtained in step S3, but when the chroma correction is performed in accordance with the category, the quality of the image may be corrected more appropriately.

For example, as in the case of a TYPE-1 image, when a dark image is corrected in such a way as to be brighter, chroma is likely to be lost. Therefore, a relatively high degree of chroma correction is performed, so that chroma is enhanced. In the case of a TYPE-2 image such as an animation or an illustration, since chroma is originally high, the degree of chroma correction is low, so that colors do not become too intense. If redness in flesh colors is too intense, the flesh colors seem unnatural. Therefore, in the case of a TYPE-3 image, the same operation as that for the TYPE-2 image is performed. Since a TYPE-4 image is a well-balanced image, chroma enhancement is performed with the degree thereof being not very high.

The classification into the categories (TYPEs), the brightness correction, and the chroma correction are not limited to those described above, but various modifications are possible. Furthermore, more detailed categories may be obtained using the variance. For example, in addition to the above examples, categories according to the frequencies of appearance of the memory colors such as blue sky and plants may be used. In the detection of the memory colors, especially in the detection of flesh colors, pattern matching may be used instead of the frequencies of appearance.

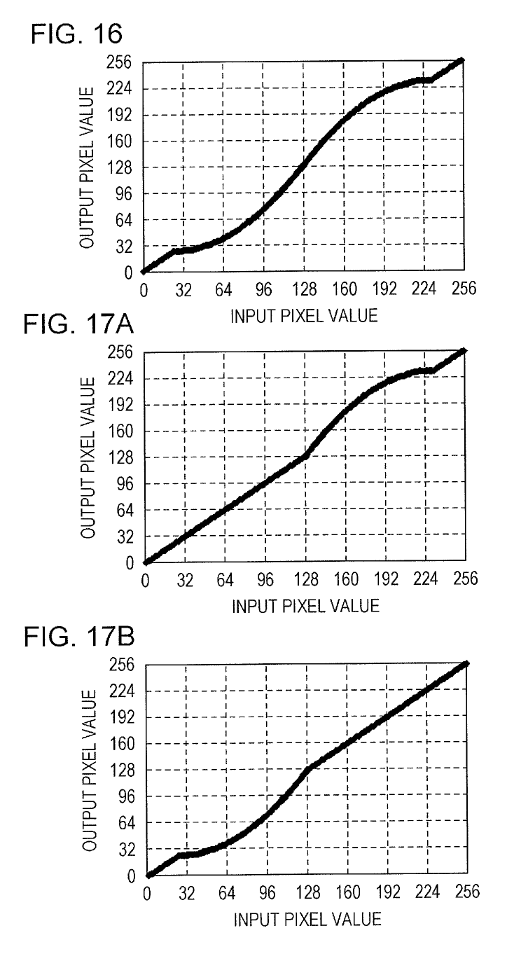

FIG. 16 is a diagram illustrating an example of a conversion curve in the chroma correction performed in the same way regardless of the categories and an example of a tone curve in chroma enhancement. The input pixel values are Cb and Cr.

In the chroma enhancement, because red (R) tends to be too intense, the characteristics of the chroma enhancement may be set such that enhancement is not performed on saturation regions of chroma and chroma is enhanced in regions in which chroma is low to moderate.

In spite of the above chroma enhancement, the hues and the chroma of blue (B) and green (G) represented by blue sky and plants, respectively, might still seem insufficient when these colors are displayed on color electronic paper. Therefore, in steps S5 to S8, the specific color correction unit 35 corrects the hues and the chroma only in the B region and the G region.

In step S5, the specific color correction unit 35 judges whether or not the frequency of appearance of plants is larger than a certain value. If so, the process proceeds to step S6, and if not, the process proceeds to step S7. The certain value may be, for example, 10% of the entirety of the image, and the range of YCbCr that defines plants is appropriately determined.

In step S6, the specific color correction unit 35 executes chroma correction for making the colors of the plants vivid.

In step S7, the specific color correction unit 35 judges whether or not the frequency of appearance of blue sky is larger than a certain value. If so, the process proceeds to step S8, and if not, the process proceeds to step S9. The certain value may be, for example, 20% of the entirety of the image, and the range of YCbCr that defines blue sky is appropriately determined.

In step S8, the specific color correction unit 35 executes chroma correction for making the colors of the blue sky vivid.

FIGS. 17A and 17B are diagrams illustrating examples of a tone curve in the process for correcting chroma in which the colors of plants and blue sky become vivid.

FIG. 17A illustrates an example of the tone curve in the correction of blue, that is, the correction of blue sky, which converts Cb values of YCbCr. Because a region of Cb values of 128 to 255 corresponds to blue (B), these values are corrected in such a way as to be larger. By enhancing the Cb values in this region, the chroma of blue (B) improves and the hues become clearer.

FIG. 17B illustrates an example of the tone curve in the correction of green, that is, the correction of plants, which converts the Cb values and Cr values of YCbCr. Because a region of Cb values and Cr values of 0 to 128 corresponds to green (G), these values are corrected in such a way as to be larger. By enhancing the Cb values and the Cr values in this region, the chroma of green, which is a color region difficult to be displayed satisfactorily on a reflective color display apparatus in which liquid crystal panels including a cholesteric liquid crystal are stacked, may be improved.

The frequencies of appearance for detecting the memory colors such as blue sky and plants may be arbitrarily set, but in most cases, the frequencies of appearance are set such that “blue sky>plants>flesh colors”.

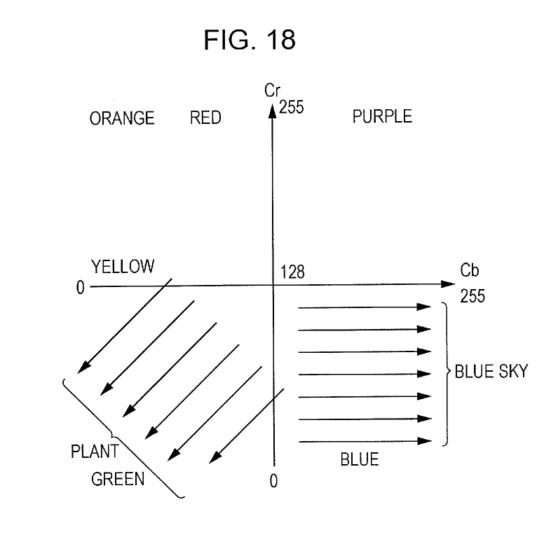

FIG. 18 is a diagram illustrating the distribution of colors in a plane defined by orthogonal axes Cr and Cb and directions in which the colors of blue sky and plants are corrected in the chroma enhancement. As illustrated in FIG. 18, the hue changes from red to orange, yellow, green, blue, and to purple on this plane in one round. When the correction has been performed such that the chroma of blue sky is enhanced, the chroma of blue is enhanced in a region of Cb values of 128 to 255, and therefore there is a change indicated by arrows in FIG. 18 named “blue sky” as a result of the correction. When the correction has been performed such that the chroma of plants is enhanced, the chroma of green is enhanced in a region of Cb values and Cr values of 0 to 128, and therefore there is a change indicated by arrows in FIG. 18 named “plant” as a result of the correction.

In step S9, the color space/RGB conversion unit 36 converts the color space image data YCbCr that has been subjected to the above correction process into RGB image data in accordance with the above-described conversion expressions for converting YCbCr into RGB.

In step S10, the drive control circuit 29 executes halftone processing (halftoning). In the halftoning, error diffusion is preferable in terms of the quality of display. Error diffusion of a Floyd type, which is the most standard type, is also preferable in the case of multi-tone display. In addition to the error diffusion, a blue noise mask is a method that makes it possible to further increase the processing speed without deteriorating the quality of display much.

As described above, in the process for correcting the quality of images, use of a DSP, which is a CPU for signal arithmetic processing, is preferable since high-speed processing is possible. In this case, software pipeline processing (so-called parallel processing of loop functions) is important to increase the processing speed. In the first embodiment, it is preferable that loop computing is performed separately in steps S2 and S3, in which the feature values of an image to be displayed are detected, steps S4 to S8, in which the brightness correction, the chroma correction, and the correction of the memory colors are performed, and step S10, in which the halftoning is performed, because the possibility of the software pipeline processing increases. Furthermore, in the first embodiment, since a conditional expression (an if statement or a switch statement in C language) that may affect the high-speed processing is not used, this embodiment is advantageous in terms of increasing the processing speed.

Therefore, a DSP is superior to a general-purpose CPU to execute a processing algorithm according to the first embodiment. For example, the time taken for a DSP (500 MHz) into which the algorithm according to the first embodiment is incorporated to process an original image of XGA (1,024×768 pixels) is 0.2 second, which is high-speed processing in which the user does not recognize delay in the response. In addition, power consumption is desirably small.

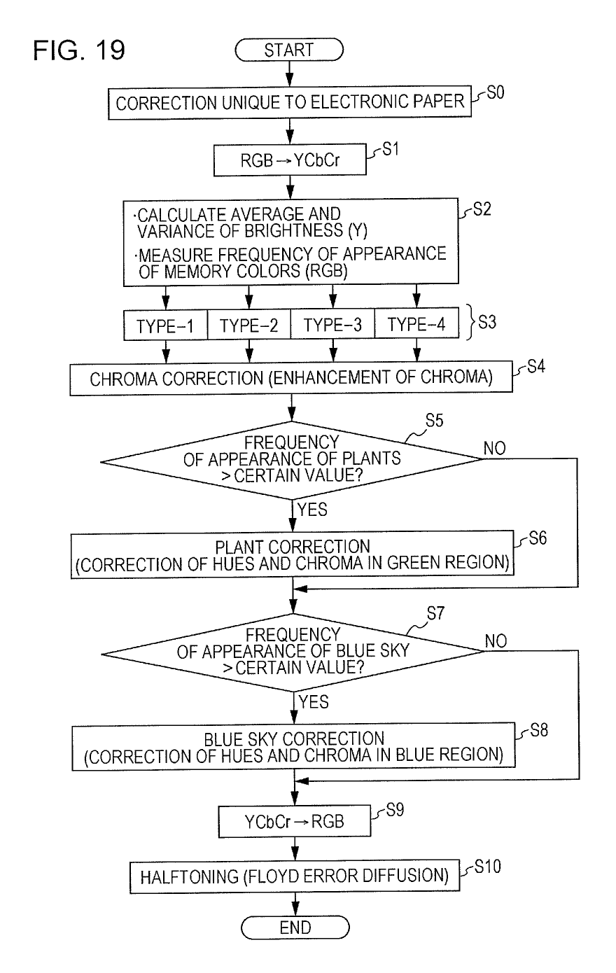

FIG. 19 is a diagram illustrating the operation flow of a process for correcting colors executed by a drive control circuit of a reflective color display apparatus according to a second embodiment. The reflective color display apparatus according to the second embodiment has the same configuration as the reflective color display apparatus according to the first embodiment. Only the processing executed by a drive control circuit 29 is different.

The processing executed by the drive control circuit 29 according to the second embodiment is different from that according to the first embodiment in that step S0, in which correction unique to electronic paper is performed, in added and the chroma correction in step S4 is performed in the same way regardless of the categories (TYPEs).

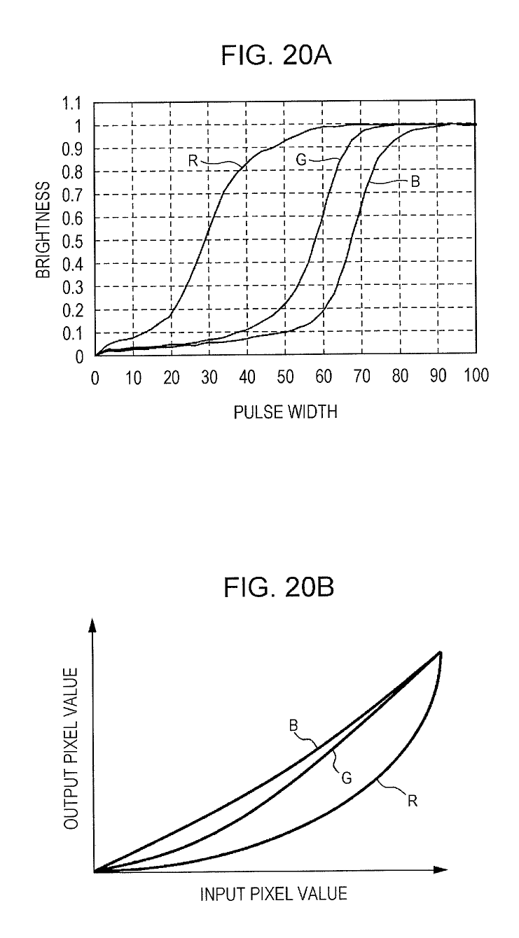

FIGS. 20A and 20B are diagrams illustrating conversion characteristics in correction of differences in changes in brightness and response characteristics between R, G, and B layers when the widths of write pulses have been changed by conventional driving in a reflective color display apparatus in which liquid crystal panels including a cholesteric liquid crystal are stacked.

In FIG. 20A, “R”, “G”, and “B” represent changes in the brightness of the R, G, and B layers, respectively, when the widths of the write pulses have been changed. As illustrated in FIG. 20A, as the widths of the write pulses become larger, the brightness of the R layer increases first, then the brightness of the G layer increases, and finally the brightness of the B layer increases. Thus, there are differences in response characteristics between the R, G, and B layers. Therefore, when a color display element 10 having these response characteristics are driven using RGB data, a red cast, which is a phenomenon in which red is displayed strongly, occurs.

Therefore, in the second embodiment, a panel response characteristics correction unit that corrects differences in response characteristics between the R, G, and B layers, which are characteristics unique to electronic paper, is provided in the drive control circuit 29. The panel response characteristics correction unit is realized by a DSP or the like. In step S0, the panel response characteristics correction unit corrects differences in response characteristics between the R, G, and B layers in RGB image data regarding the full-color original image.

In FIG. 20B, “R”, “G”, and “B” represent conversion characteristics for correcting differences in response characteristics between the R, G, and B layers relative to the RGB input pixels values. The output pixel values are smaller in small and moderate regions of the R input pixel values, and the output pixel values are smaller in a small region of the G input pixel values. The output pixel values are proportionate to the B input pixel values in all regions.

The correction process in the panel response characteristics correction unit may be performed while providing an LUT for each of RGB. When the correction is to be performed in a more detailed manner, a detailed table such as an International Color Consortium (ICC) profile may be set. Although three primary colors of RGB have been assumed in the above description, the above embodiments may be applied to image data using other three primary colors such as CMY.

Furthermore, in step S4, for example, chroma correction having the conversion characteristics illustrated in FIG. 16 is performed on YCbCr of all the categories.

As described above, in the first and second embodiments, color electronic paper capable of providing high-quality display may be realized by executing the process for correcting the quality of images in which a high-quality image and high-speed processing are achieved while covering the small color reproduction range of the color electronic paper as much as possible.

Although the cholesteric liquid crystal display element has been taken as an example in the embodiments, a display element adopting a material other than the cholesteric liquid crystal may be used so long as the display element is a reflective display element.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A color display method in which display is realized by controlling, on the basis of image data having three primary colors, a reflective color display element in which three display panels are stacked, the color display method comprising:
converting the image data having the three primary colors into color space image data;
classifying an image into one of a plurality of categories on the basis of criteria relating to brightness, hues, and chroma of the image;
correcting the brightness of the color space image data in accordance with correction characteristics of the corresponding category;
correcting the chroma of the color space image data whose brightness has been corrected; and
converting the color space image data whose chroma has been corrected into image data having the three primary colors.

2. The color display method according to claim 1,
wherein the classifying is performed in accordance with distribution information regarding the brightness and frequencies of appearance of specific colors.

3. The color display method according to claim 1,
wherein the color space image data is YCbCr data.

4. The color display method according to claim 1,
wherein the correcting the chroma is performed by correcting the chroma of the color space image data in accordance with the correction characteristics of the corresponding category.

5. The color display method according to claim 1, further comprising:
judging whether or not the color space image data whose chroma has been corrected includes specific colors, and, if so, correcting hues or chroma of the specific colors.

6. The color display method according to claim 1, further comprising:
performing panel characteristic correction in which the image data having the three primary colors is corrected on the basis of optical response characteristics of the three display panels,
wherein the image data having the three primary colors that has been subjected to the panel characteristic correction is converted into the color space image data.

7. The color display method according to claim 1,
wherein the three display panels are liquid crystal display panels including a cholesteric liquid crystal.

8. The color display method according to claim 1,
wherein the image data having the three primary colors uses red, green, and blue.

9. The color display method according to claim 1, further comprising:
performing halftoning after the converting the image data having the three primary colors into color space image data.

10. A color display apparatus comprising:
a reflective color display element in which three display panels are stacked; and
a drive control circuit that controls the reflective color display element on the basis of image data having three primary colors,
wherein the drive control circuit includes
a color space conversion unit that converts the image data having the three primary colors into color space image data,
a classification unit that classifies an image into one of a plurality of categories on the basis of criteria relating to brightness, hues, and chroma of the image,
a brightness correction unit that corrects the brightness of the color space image data in accordance with correction characteristics of the corresponding category,
a chroma correction unit that corrects the chroma of the color space image data whose brightness has been corrected, and
a three primary colors conversion unit that converts the color space image data whose chroma has been corrected into image data having the three primary colors.

11. The color display apparatus according to claim 10,
wherein the classification unit classifies the image in accordance with distribution information regarding the brightness and frequencies of appearance of specific colors.

12. The color display apparatus according to claim 10,
wherein the color space image data is YCbCr data.

13. The color display apparatus according to claim 10,
wherein the chroma correction unit corrects the chroma of the color space image data in accordance with the correction characteristics of the corresponding category.

14. The color display apparatus according to claim 10, further comprising:
a specific color correction unit that judges whether or not the color space image data whose chroma has been corrected includes specific colors and that, if so, corrects hues or chroma of the specific colors.

15. The color display apparatus according to claim 10, further comprising:
a panel characteristic correction unit that corrects the image data having the three primary colors on the basis of optical response characteristics of the three display panels,
wherein the color space conversion unit converts the image data having the three primary colors that has been corrected by the panel characteristic correction unit into color space image data.

16. The color display apparatus according to claim 10,
wherein the three display panels are liquid crystal display panels including a cholesteric liquid crystal.

17. The color display apparatus according to claim 10,
wherein the image data having the three primary colors uses red, green, and blue.

18. The color display apparatus according to claim 10, further comprising:
a halftone processing unit that performs halftoning after the conversion performed by the three primary colors conversion unit.
